(19) United States
(12) Patent Application Publication
(10) Pub. No.: US 2014/0086442 A1
(43) Pub. Date: Mar. 27, 2014

(54) FURNITURE

(71) Applicant: GOTO DENSHI CO., LTD., Sagae-shi (JP)

(72) Inventors: Yoshihide GOTO, Sagae-shi (JP); Taiki GOTO, Sagae-shi (JP)

(73) Assignee: GOTO DENSHI CO., LTD., Sagae-shi (JP)

(21) Appl. No.: 13/847,351

(22) Filed: Mar. 19, 2013

(30) Foreign Application Priority Data
Sep. 25, 2012 (JP) 2012-211240

(51) Int. Cl. H04R 1/02

(52) U.S. Cl. CPC H04R 1/028
USPC 381/333

(57) ABSTRACT

A furniture including at least one leg, said at least one leg includes a cavity, a speaker, and at least one hole connecting the cavity with outside of the leg. The cavity is provided inside the leg while the speaker is provided inside the cavity or toward the cavity.

This application claims priority under 35 U.S.C. § 119 to Japanese Patent Application Serial No. 2012-211240, filed on Sep. 25, 2012, entitled “Furniture”, which is hereby expressly incorporated by reference in its entirety for all purposes.

### TECHNICAL FIELD

The present invention generally relates to furniture and, but not by way of limitation, to a space-saving furniture which is capable of highly efficient audio reproduction.

### BACKGROUND OF THE DISCLOSURE

In recent years, the popularity of personal computers, portable music players, smart phones, tablet devices, etc. is increasing. These devices can play music and videos.

However, when playing music or videos using these devices, the volume or quality of a sound is often unsatisfactory. Therefore, in order to improve the sound volume or sound quality, there is a need to provide a speaker separately.

However, installing such a speaker requires a large open space. In particular, when installing the speaker on a table or a desk, it tends to cause a reduction in working space and deterioration of aesthetics. In addition, such speakers tend to have an unsatisfactory reproduction of bass. In such a case, subwoofers or the like are used, but these further require a large open space.

### SUMMARY OF THE INVENTION

The present invention has an objective of providing a system that is space-saving and capable of highly efficient audio reproduction.

According to one aspect of the present invention, there is provided a furniture for highly efficient audio reproduction. The furniture may include at least one leg where said at least one leg includes: a cavity provided inside the leg; a speaker provided inside the cavity or toward the cavity; and at least one hole connecting the cavity with outside of the leg.

According to the present invention, it is possible to provide a system that is space-saving and capable of highly efficient audio reproduction.

### BRIEF DESCRIPTION OF DRAWINGS

The present disclosure is described in conjunction with the appended figures:

FIG. 1 is a perspective view illustrating the furniture according to one embodiment of the present invention.

FIG. 2 is an enlarged view showing an example of the structure of the leg of furniture shown in FIG. 1.

FIG. 3 is an enlarged view showing another example of the structure of the leg of furniture shown in FIG. 1.

FIG. 4 is a perspective view showing a usage example of the furniture shown in FIG. 1.

FIG. 5 is a perspective view illustrating the furniture according to another embodiment of the present invention.

FIG. 6 is a perspective view illustrating the furniture according to another embodiment of the present invention.

FIG. 7 is an enlarged view showing an example of the structure of the leg of furniture shown in FIG. 6.

FIG. 8 is a perspective view showing the bottom portion of the furniture shown in FIG. 6.

FIG. 9 is a schematic diagram showing the bottom portion of the furniture shown in FIG. 6.

In the appended figures, similar components and/or features may have the same reference label. Further, various components of the same type may be distinguished by following the reference label by a dash and a second label that distinguishes among the similar components. If only the first reference label is used in the specification, the description is applicable to any one the similar components having the same first reference label irrespective of the second reference label.

### DETAILED DESCRIPTION OF THE INVENTION

Embodiments of the present invention will be described hereinafter with reference to the accompanying drawings, in which preferred exemplary embodiments of the invention are shown. The ensuing description is not intended to limit the scope, applicability or configuration of the disclosure. Rather, the ensuing description of the preferred exemplary embodiments will provide those skilled in the art with an enabling description for implementing preferred exemplary embodiments of the disclosure. It should be noted that this invention may be embodied in different forms without departing from the spirit and scope of the invention as set forth in the appended claims.

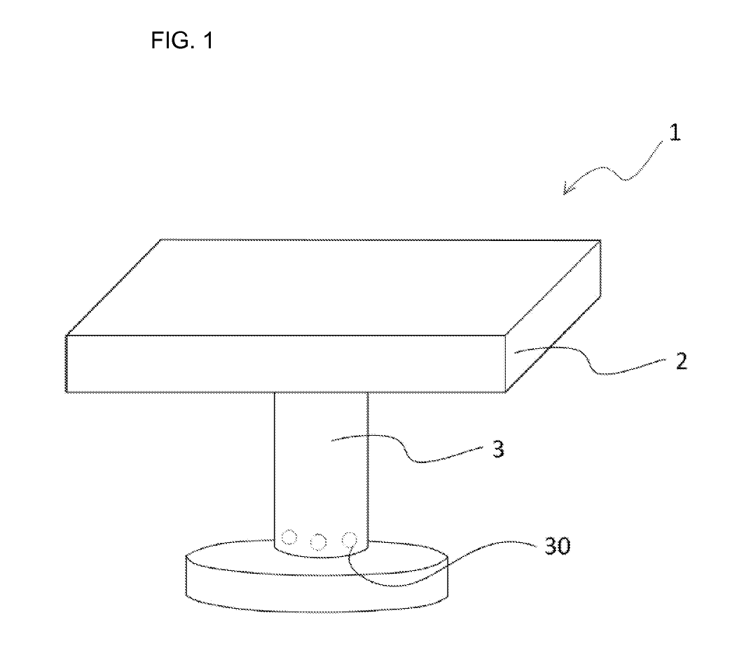

FIG. 1 is a perspective view showing the furniture according to one embodiment of the present invention. As an example of the furniture 1, a table is depicted in FIG. 1.

As shown in this figure, the furniture 1 may include a top plate 2 and a table leg 3 for supporting the top table 2. As will be described further below, the table leg 3 may also include a speaker in the inside and a plurality of holes 30 on its outer surface.

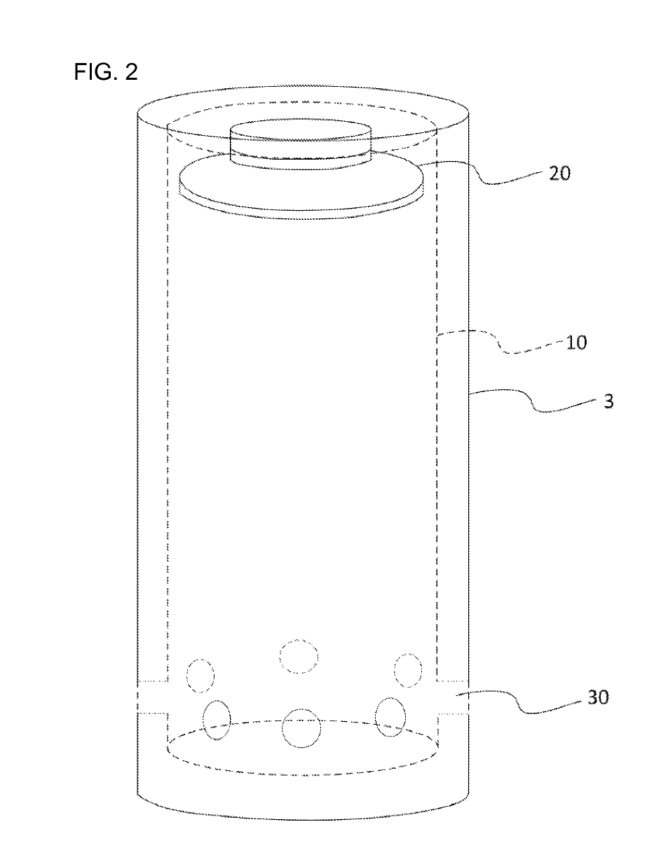

FIG. 2 is an enlarged view showing an exemplary embodiment of table leg 3, which is used in furniture 1 of FIG. 1. As shown in this figure, the table leg 3 has a cylindrical shape with a hollow structure. That is, the table leg 3 may include a cavity 10 in its inside. In this embodiment, the cavity 10 has a cylindrical shape extending along a length direction of table leg 3. That is, in this example, the diameter of the cavity 10 is constant along the length direction of table leg 3.

As shown in FIG. 2, a speaker 20 is installed at one end of the cavity 10. The speaker 20 is connected to an audio playback device (not shown in this figure), which will be described further below. The speaker 20 has the role of playing a sound from the audio playback device at higher quality and volume.

At the other end of the cavity 10, a plurality of holes 30 is provided for connecting the cavity 10 to the outside of table leg 3. The plurality of holes 30 are provided for transmitting a sound reproduced from the speaker 20 to the user of the furniture 1.

It should be noted herein that the “end” refers to the portions excluding the central portion when the length of the cavity 10 is divided into three equal parts.

As described above, the furniture 1 is provided with a speaker 20 in the interior of the table leg 3. That is, if furniture 1 is used, there is no need to provide a speaker separately. Therefore, it is possible to save space as well as to play back an audio without impairing the aesthetics of the interior.

Moreover, the sound waves generated in this cavity 10 are obstructed by the wall, and unlikely to spread randomly. Therefore, a large part of these sound waves is transmitted to the outside of the table leg 3 through the plurality of holes 30 described above. Therefore, by employing such a configuration, it is possible to play back a sound at a higher volume with less power. That is, thereby, highly efficient audio playback can be achieved.

As described above, the cavity 10 is formed in a shape that extends along the length direction of table leg 3. In addition, a speaker 20 is provided at one end of cavity 10 while the plurality of holes 30 is provided in the other end. By adopting such a configuration, the audio played back from the speaker 20 is amplified, and an excellent reproduction of the audio with realistic sensation can be achieved.

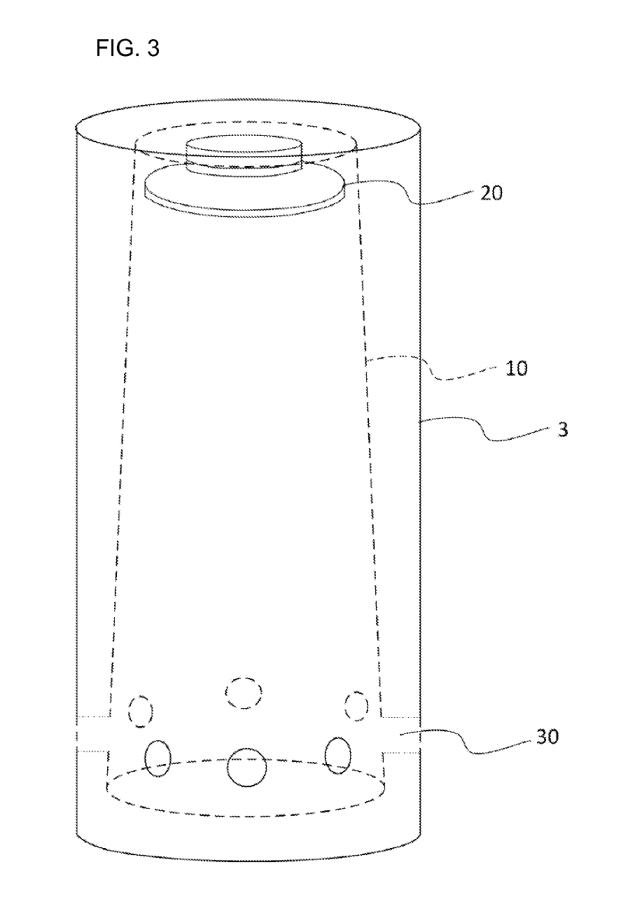

Referring next to FIG. 3, an enlarged view of an alternative embodiment of a table leg 3 is shown. In this embodiment, the cavity 10 has a shape wherein the diameter of the cavity 10 increases monotonically from one end toward the other end. By adopting such a configuration, the audio amplification described above becomes even more pronounced. Therefore, an excellent reproduction of audio with even more realistic sensation can be achieved.

As described above, in the embodiment shown in FIG. 3, the diameter of cavity 10 increases monotonically and continuously from one end towards the other end. In other embodiments, the cavity 10 may have a shape wherein the diameter increases monotonically and discontinuously from one end towards the other end. For example, the cavity 10 may also have a shape wherein the diameter increases from one end towards the other end in incremental steps.

Here, if a cross-sectional shape of the cavity 10 in a plane perpendicular to the length direction is circle, the “diameter” refers to the diameter thereof. In a case where, the cross-sectional shape of the cavity 10 in a plane perpendicular to the length direction is not circle, such “diameter” refers to the diameter of the circle whose area is equal to the above-mentioned cross-section.

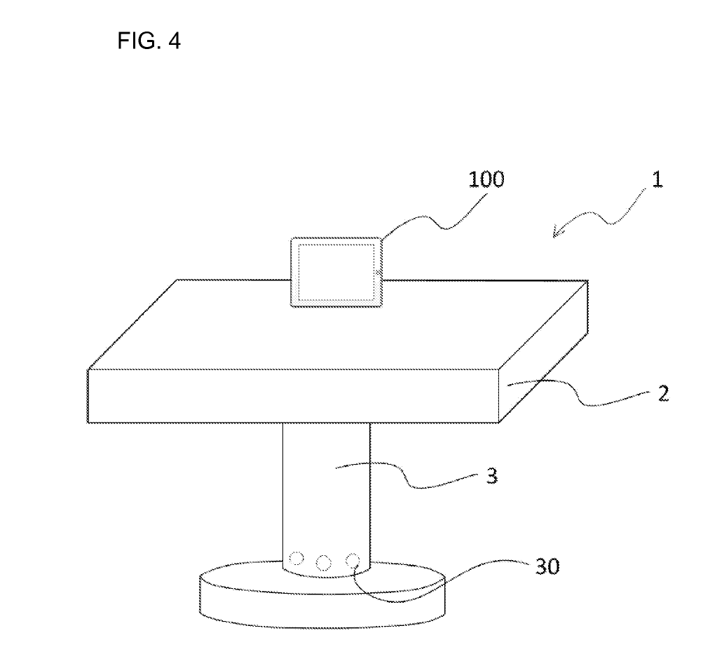

FIG. 4 is a perspective view showing an example of usage of the subject design. As an example, FIG. 4 depicts a tablet device as an audio playback device 100 that is used with furniture 1.

The furniture 1 shown in FIG. 4 has a configuration capable of receiving audio information from the audio playback device 100. This configuration may be a configuration with either wired connection or wireless connection. In the former case, typically, a connection port that allows an audio cable connection is provided within furniture 1. In the latter case, a receiver to enable wireless reception of information is typically provided within the furniture 1.

A groove or a holder (not shown in FIG. 4) for supporting the audio playback device 100 may also be provided with furniture 1. In this case, the installation of the audio playback device 100 on the furniture 1 will be even easier. In this embodiment, the groove or holder may have a configuration so as to support the audio playback device 100 in an inclined position. In this way, users of furniture 1 are able to see the screen of audio playback device 100 more easily.

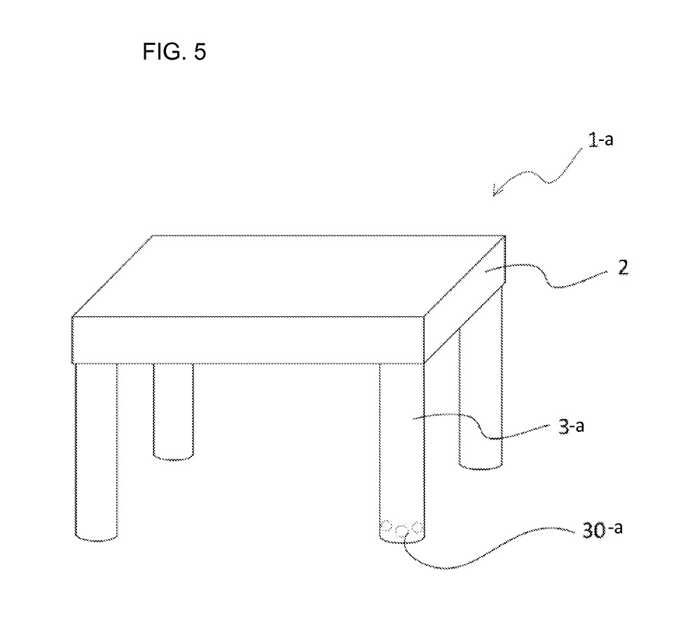

FIG. 5 is a perspective view showing an alternative embodiment of a furniture 1. This embodiment differs from that of FIG. 1 in that four table legs 3-a are provided for supporting the table top 2. In this embodiment, one speaker 20 may be embedded in at least one of the table leg 3-a.

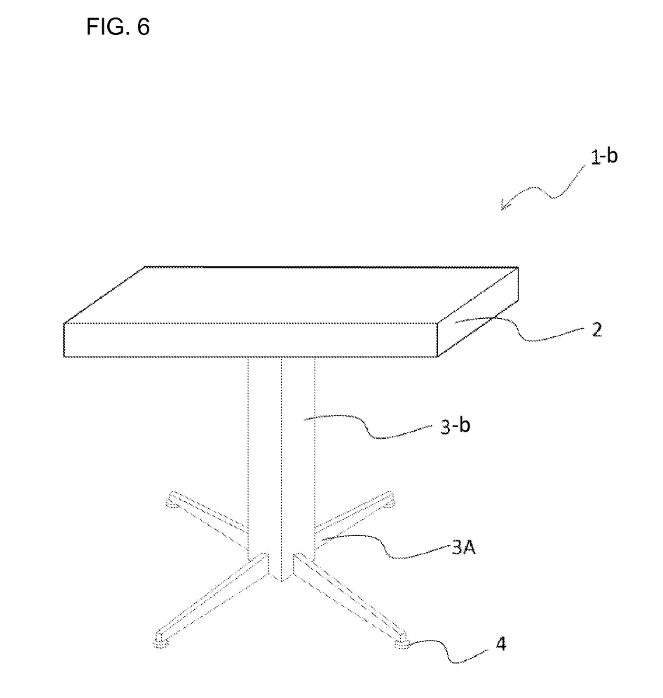

With reference to FIG. 6, a perspective view of yet another embodiment of furniture 1-b is shown. This embodiment differs from that of FIG. 1 in that the table leg 3-b has a quadrangular prism shape and the plurality of holes 30-b are provided at the bottom of table leg 3-b (not shown in this figure). In addition, four sub-legs 3A and four height adjustment devices 4 are provided at a bottom end of said table leg 3-b. As shown in FIG. 6, the four sub-legs 3A are attached to the bottom part of the table leg 3-b and for each of the sub-legs 3A one height adjustment device 4 is provided at their ends. With the help of this height adjustment device 4, it is possible to move the bottom portion of table leg 3-b away from the floor. That is, according to this embodiment, the plurality of holes 30-b are formed at a bottom surface of table leg 3-b, and said bottom surface is separated from the floor when the furniture 1 is installed.

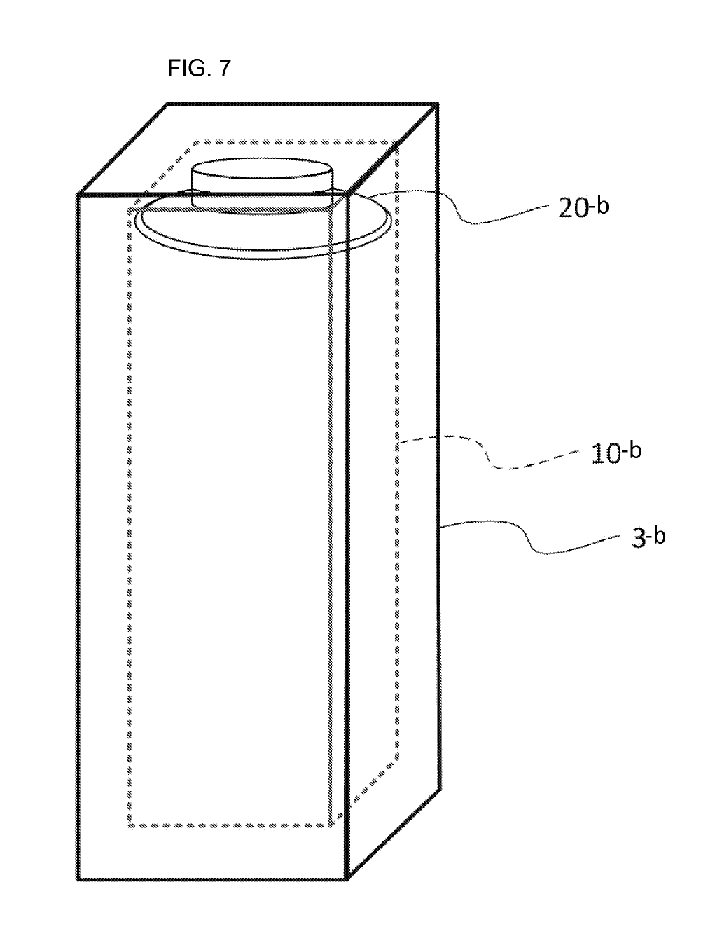

FIG. 7 is an enlarged view showing an exemplary embodiment of table leg 3-b, which is used in furniture 1-b of FIG. 6. As described above and also shown in FIG. 7, the table leg 3-b has a quadrangular prism shape with a hollow structure. Accordingly, the table leg 3-b may include a cavity 10-b which has a quadrangular prism shape extending along a length direction of the table leg 3-b. Similar, to the embodiment shown in FIG. 2, a speaker 20 is installed at one end of the cavity 10-b. Similarly, the speaker 20-b is connected to an audio playback device (not shown in this figure). The speaker 20-b has the role of playing a sound from the audio playback device at higher quality and volume.

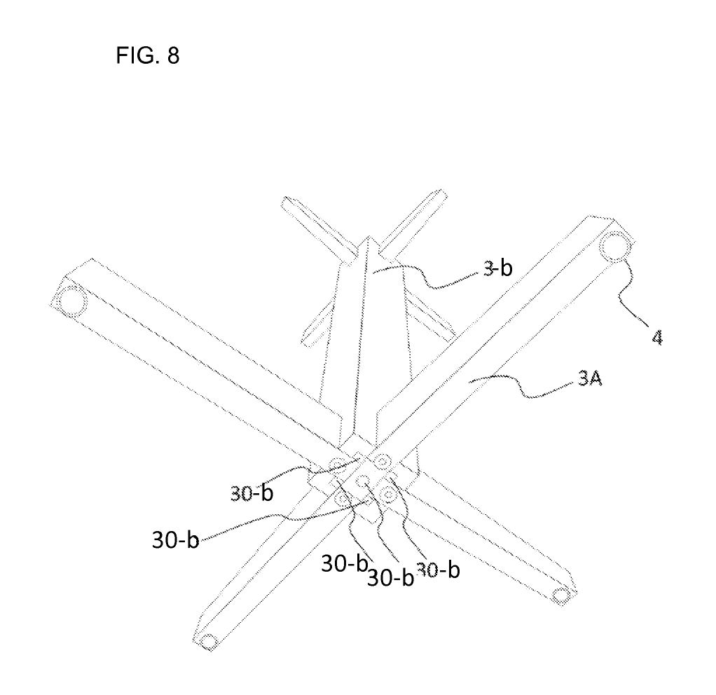

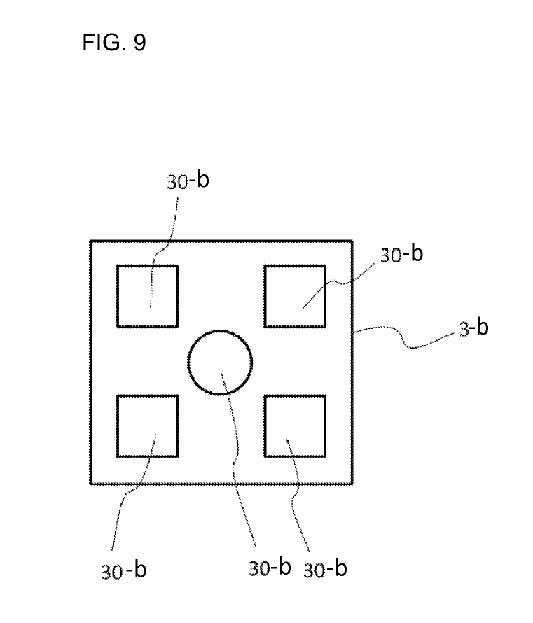

FIG. 8 is a perspective view showing a bottom portion of furniture 1-b shown in FIG. 6. Accordingly, FIG. 9 represents a schematic diagram showing the bottom portion of furniture 1-b. As described previously and also shown in FIGS. 8 and 9, the plurality of holes 30 are provided at the bottom of table leg 3-b of furniture 1-b. By employing such a configuration, when furniture 1-b is installed, the plurality of holes 30-b will not be visible to users. Accordingly, the effect explained above can be achieved without affecting the aesthetics of the furniture 1-b.

The terms and expressions which have been employed are used as terms of description and not of limitation, and there is no intention in the use of such terms and expressions of excluding any equivalents of the features shown and described or portions thereof, it being recognized that various modifications are possible within the scope of the invention. Some examples of those variations are shown below without restriction.

There is no limit to the material and design of the top plate 2 and table leg 3. For example, the table leg 3 may be of cylindrical, prismatic or truncated cone shape.

There is no restriction on the number of table legs 3. The speaker 20 may be provided only in one of table legs 3, or only in a part of a leg 3, or in all of table legs 3.

There is no restriction with regard to the shape and size of the cavity 10. The shape of the cavity 10 can be mutually identical with or mutually different from the shape of table leg 3. In the latter case, for example, it is possible to adopt a configuration wherein the shape of the table leg 3 is quadrangular prism and the cavity 10 is of cylindrical shape.

There is no restriction on the type and configuration of the speaker 20. For example, the speaker 20 may be a woofer or a subwoofer. In this way, the reproduction of bass is enhanced, and it is possible to achieve playback of sound with more realistic sensation. Further, the speaker 20 may be disposed inside the cavity 10 or may be disposed towards the cavity 10.

There is no restriction with regard to the number, size and shape of the plurality of holes 30. For example, the number of plurality of holes 30 may be one or multiple. Also, the plurality of holes 30 may be provided uniformly or unevenly around the table leg 3. In the latter case, for example, a majority of the plurality of holes 30 may be provided at a location directed towards a user of the furniture 1. With this, it becomes possible to deliver a sound to the user of furniture 1 with even higher efficiency.

There is no restriction on the type of audio playback device 100. For example, the audio playback device 100 may be a desktop or laptop personal computer, a portable music player or maybe even a smart phone. Alternatively, the audio playback device 100 may be a system for teleconferencing.

There is no restriction on the type of furniture 1 as long as it is equipped with table leg 3. For example, furniture 1 may be a table, a desk or a chair, a rack or even a drawer.

There is also no restriction on the usage of furniture 1. Furniture 1 may be used inside a house or in a public place. For example, furniture 1 may be used in coffee shops, restaurants, or in waiting rooms at a railway station or an airport. In such a case, for example, at each table, users will be able to enjoy music and video. In other words, the furniture 1 is also suitable for commercial use in the service sector.

### Experimental Design

First, furniture 1-b shown in FIG. 6 of this disclosure is manufactured. In this embodiment, the table leg 3-b has a square columnar shape, and the length of one side of the cross section was 85 mm, and the height was 670 mm. Inside of the table leg 3-b, a cavity 10-b having a square columnar shape with a cross-sectional length of 53 mm and a height of 550 mm is formed. A speaker 20 for a woofer is also disposed near the upper end of this cavity 10-b. Also, at the bottom of table leg 3, the plurality of holes 30 are provided. The diameter of the central circular hole 30 is 14 mm. The length of one side of a square hole 30 in the peripheral portion is 11 mm. In addition, the height of the height adjustment device is 10 mm.

In addition, a groove for supporting a tablet device 100 is provided on the top plate 2 so that an angle of the screen is adjustable. The groove is designed to have a length of 250 mm, a width of 11 mm, and a depth of 12 mm.

Further, a speaker 20 is provided inside the table leg 3. That is, by using the furniture 1, it was possible to eliminate the space separately required for installing the speaker 20. In this way, the speaker 20 is not visible from the outside. Therefore, furniture 1 has a clean appearance, and also has excellent interior aesthetics.

Next, a tablet device as an audio playback device 100 is installed on the furniture 1. Then, using this experimental device, a sound is played back from the tablet device 100. As a result, it became evident that a sound can be played with high efficiency and excellent quality.

While the principles of the disclosure have been described above in connection with specific apparatuses and methods, it is to be clearly understood that this description is made only by way of example and not as limitation on the scope of the invention.

What is claimed is:

1. A furniture comprising at least one leg, wherein the at least one leg comprises:
a cavity provided inside the leg;
a speaker provided inside the cavity or toward the cavity; and
at least one hole connecting the cavity with outside of the leg.

2. The furniture according to claim 1, wherein the furniture is a table or a desk.

3. The furniture according to claim 1, further comprising a component configured to receive sound information from a sound playing device.

4. The furniture according to claim 3, further comprising a groove or a holder to support the sound playing device.

5. The furniture according to claim 1, wherein the cavity elongates along a longitudinal direction of the at least one leg.

6. The furniture according to claim 5, wherein the speaker is provided in one side of the cavity or toward the one side of the cavity, and the at least one hole is provided at another side of the cavity, opposite from the speaker.

7. The furniture according to claim 6, wherein the cavity has a shape in which a diameter increases monotonically from the one side of the cavity to the other side of the cavity.

8. The furniture according to claim 1, wherein said at least one hole comprises multiple holes.

9. The furniture according to claim 8, wherein the multiple holes are provided unevenly around said at least one leg such that a majority of the plurality of holes is provided in a position directed toward a user of said furniture.

10. The furniture according to claim 1, wherein the at least one hole is provided on a bottom portion of said at least one leg.

11. The furniture according to claim 10, wherein the bottom portion is configured to be apart from a floor when the furniture is installed.
